(19) United States
(12) Patent Application Publication
(10) Pub. No.: US 2008/0219801 A1
(43) Pub. Date: Sep. 11, 2008

(54) Screw Fastener

(75) Inventor: Peter James Toenjes, Gross Pointe Farms, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills (US)

(21) Appl. No.: 11/715,920

(22) Filed: Mar. 9, 2007

(51) Int. Cl. F16B 35/00

(52) U.S. Cl. 411/413; 411/311

(57) ABSTRACT

A screw fastener includes a head portion, a shaft portion extending from the head portion, and at least one locking serration. The shaft portion has a helical thread structure defining a thread part and a root part. The locking serration protrudes from the root part of the helical thread structure. The locking serration is configured and arranged to allow rotation of the shaft portion in a fastening direction and to restrict rotation of the shaft portion in a non-fastening direction upon engaging with a workpiece.

### BACKGROUND OF THE INVENTION

1. Field of the Invention

The present invention generally relates to a screw fastener. More specifically, the present invention relates to a screw fastener having a self-locking feature.

2. Background Information

Many self-locking features for threaded fasteners (e.g., bolts and screws) have been proposed in the past. For example, U.S. Pat. No. 4,808,050 discloses a conventional vibration resistant fastener having a plurality of serrations formed on a bottom surface (bearing surface) of a screw head to provide resistance against the fastener becoming loosened unintentionally after it has been seated in a workpiece. U.S. Pat. No. 3,982,575 discloses a conventional thread forming fastener having a plurality of self-locking serrations or teeth formed on both flanks of the thread. Moreover, U.S. Pat. No. 3,726,330 discloses a conventional screw fastener having a shaft with a plurality of serrations or grooves formed on a surface of a wall portion (i.e., root portion) of the shaft. This reference further discloses that the grooves on the wall portion are engaged by plastic material of a workpiece to secure the screw fastener in position.

Also, U.S. Pat. No. 4,544,313 discloses a conventional self-tapping screw in which a root part of a shaft has a constricted portion (recess) so that material of a workpiece which is moved as a thread of the self-tapping screw engages the workpiece can flow into the recess formed in the root part. Therefore, the thread penetrates into the material until a base part of the thread engages the material, thereby increasing the supporting force for fastening the self-tapping screw.

In view of the above, it will be apparent to those skilled in the art from this disclosure that there exists a need for an improved screw fastener. This invention addresses this need in the art as well as other needs, which will become apparent to those skilled in the art from this disclosure.

### SUMMARY OF THE INVENTION

One object of the present invention is to provide a screw fastener with which the installation force required for fastening the screw fastener can be reduced while still providing the self-locking performance. Another object of the present invention is to provide a screw fastener with a self-locking function that is relatively easy to manufacture.

In order to achieve the above mentioned objects, a screw fastener is provided that includes a head portion, a shaft portion extending from the head portion, and at least one locking serration. The shaft portion has a helical thread structure defining a thread part and a root part. The locking serration protrudes from the root part of the helical thread structure. The locking serration is configured and arranged to allow rotation of the shaft portion in a fastening direction and to restrict rotation of the shaft portion in a non-fastening direction upon engaging with a workpiece.

In accordance with another aspect of the present invention, a screw fastener is provided that includes a head portion, a shaft portion extending from the head portion, and at least one locking serration. The shaft portion has a helical thread structure defining a thread part and a root part. The root part of the helical thread structure includes a pair of inclined surfaces diverging outwardly relative to a center axis of the shaft portion and defining a helical recess section extending substantially parallel to the thread part of the helical thread structure. The locking serration protrudes from the root part of the helical thread structure across the helical recess section.

These and other objects, features, aspects and advantages of the present invention will become apparent to those skilled in the art from the following detailed description,.which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is an overall perspective view of a screw fastener in accordance with a preferred embodiment of the present invention;

FIG. 2 is a side elevational view of the screw fastener in accordance with the embodiment of the present invention;

FIG. 3 is a top plan view of the screw fastener in accordance with the embodiment of the present invention;

FIG. 4 is an enlarged partial cross sectional perspective view of the screw fastener as taken along a section line 4-4 in FIG. 1 in accordance with the embodiment of the present invention;

FIG. 5 is a cross sectional view taken along a center axis of the screw fastener illustrating a state in which the screw fastener is fastened to a mounting boss of a workpiece in accordance with the embodiment of the present invention;

FIG. 6 is an enlarged schematic view of an encircled section 6 in FIG. 5 illustrating a flow of material of the workpiece in accordance with the embodiment of the present invention; and

FIG. 7 is a schematic cross sectional view of the screw fastener and the workpiece as taken along a section line 7-7 in FIG. 6 illustrating a flow of material of the workpiece in accordance with the embodiment of the present invention.

### DETAILED DESCRIPTION OF THE PREFERRED EMBODIMENTS

Selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

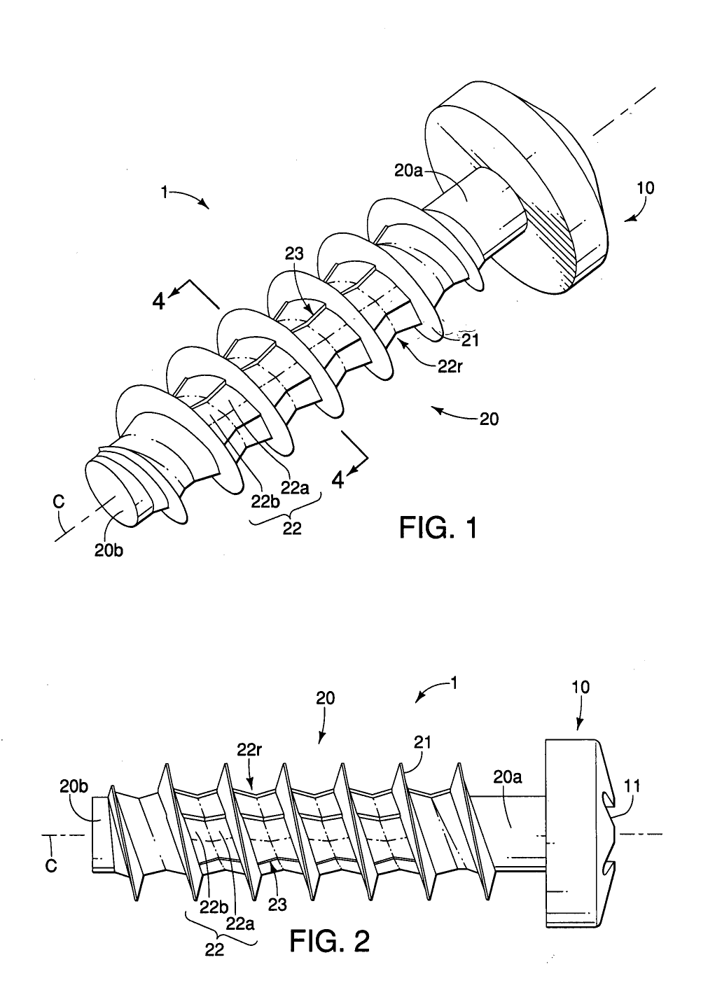

Referring initially to FIGS. 1 to 4, a screw fastener 1 is illustrated in accordance with a preferred embodiment of the present invention. As seen in FIGS. 1 and 2, the screw fastener 1 includes a head portion 10 and a shaft portion 20 (threaded portion) extending from the head portion 10.

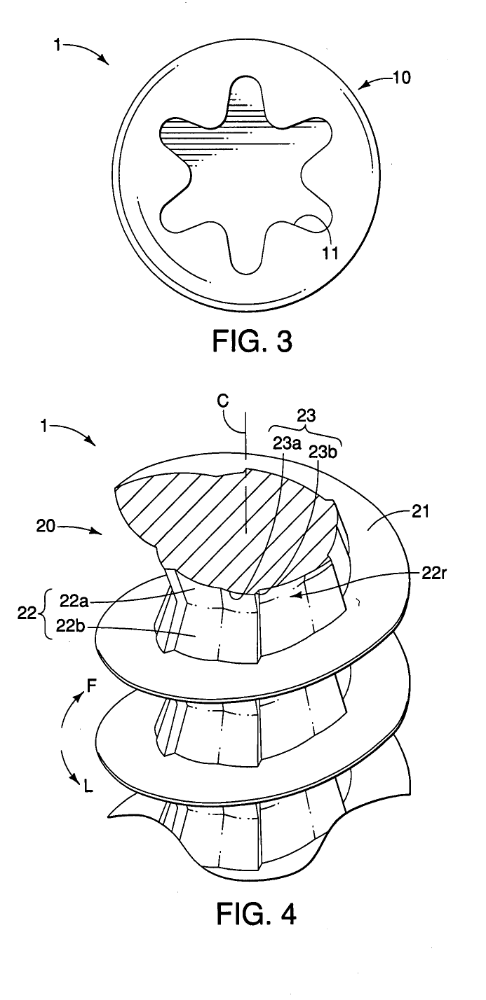

As shown in FIG. 3, the head portion 10 of the screw fastener 1 includes a drive section (torque transmitting surface) 11 that defines a recessed section on a top surface of the head portion 10. The drive section 11 is configured and arranged to engage with a tool or the like. The rotational torque applied by the tool to the drive section 11 is transmitted from the head portion 10 to the shaft portion 20 to fasten or to loosen the screw fastener 1. Although the drive section 11 of the screw fastener 3 is illustrated in FIG. 3 as having a star-shape profile, the structure of the head portion 10 is not limited to the illustrated embodiment. Rather, it will be apparent to those skilled in the art from this disclosure that any screw drive design (e.g., slotted, hex, Phillips, etc.) or any head design (e.g., hexagon head, etc.) can be utilized as long as the rotational torque can be transmitted from the head portion 10 to the shaft portion 20 to drive the screw fastener 1 by an appropriate tool (e.g., screw driver, spanner, wrench, etc.).

As shown in FIGS. 1, 2 and 4, the shaft portion 20 of the screw fastener 1 includes a shank section 20a (base end section) and a point section 20b (free end section). The shank section 20a is fixedly coupled to the head portion 10. The point section 20b is disposed opposite from the based end section 20a. The shaft portion 20 further includes a thread part 21 and a root part 22 that define a helical thread structure of the shaft portion 20. Moreover, the shaft portion 20 includes a plurality of locking serrations 23 protruding from the root part 22 of the helical thread structure.

The helical thread structure (i.e., the thread part 21 and the root part 22) extends between the shank section 20a and the point section 20b of the shaft portion 20 as shown in FIGS. 1 and 2. A radial outer edge (crest) of the thread part 21 defines the major diameter (i.e., the maximum diameter) of the helical thread structure. On the other hand, a radial inner edge of the root part 22 defines the minor diameter (i.e., the minimum diameter) of the helical thread structure. In the illustrated embodiment of the present invention, the thread part 21 and the root part 22 of the helical thread structure is preferably formed as a thread forming screw (i.e., the thread part 21 preferably has a thread forming profile). In other words, the thread part 21 is preferably configured and arranged to form a counter thread (complementary thread) in a workpiece when the shaft portion 20 is rotated in a fastening direction F (FIG. 4) while engaging with the workpiece.

Moreover, as shown in FIGS. 1 and 2, the root part 22 of the helical thread structure preferably includes a pair of inclined surfaces 22a and 22b diverging outwardly relative to a center axis C of the shaft portion 20. Thus, the inclined surfaces 22a and 22b define a helical recess section 22r extending substantially helically parallel to the thread part 21 of the shaft portion 20. The inclined surfaces 22a and 22b forming the helical recess section 22r are configured and arranged to facilitate a flow of material of the workpiece into the helical recess section 22r when the screw fastener 1 is threaded into the workpiece. In other words, the inclined surfaces 22a and 22b are configured and arranged such that the material of the workpiece, which is moved by the thread part 21 engaging the workpiece, flows into the helical recess section 22r formed in the root part 22. Therefore, the thread part 21 penetrates into the material of the workpiece until a base portion (a portion between the thread part 21 and the root part 22) engages the material. With such arrangement of the threat root part 22 having the helical recess section 22r, the installation torque required to fasten the screw fastener 1 to the workpiece can be reduced. Also, the clamp load of the screw fastener 1 can be improved. The precise dimensions of the helical recess section 22r (i.e., the inclined surfaces 22a and 22b) and the thread part 21 are set appropriately so that an optimal flow of material of the workpiece toward the helical recess section 22r can be achieved when the thread part 21 threads into the workpiece. For example, various threaded fasteners (e.g., PT® Thread-Forming Fasteners) are sold by Acument™ Global Technologies which have a recessed thread root with different dimensions for various designs.

231 As shown in FIGS. 1 and 4, the locking serrations 23 protrude from the root part 22. The locking serrations are preferably disposed in the root part 22 as being spaced apart in a circumferential direction of the shaft portion 20. As shown in FIG. 4, each of the locking serrations 23 includes a retched tooth formed by a first surface 23a and a second surface 23b. The first surface 23a of the locking serration 23 extends generally along an expanding circumferential direction with respect to the center axis C of the shaft portion 20 in a plane perpendicular to the center axis C of the shaft portion 20. The second surface 23b of the locking serration 23 extends between the first surface 23a and the root part 22 generally along a radial direction with respect to the center axis C of the shaft portion 20 in the plane perpendicular to the center axis C of the shaft portion 20. Thus, as shown in FIG. 4, the locking serrations 23 form a ratchet mechanism that is configured and arranged to allow rotation of the shaft portion 20 in the fastening direction F and to restrict rotation of the shaft portion 20 in the loosening direction L (non-fastening direction) upon engaging with the workpiece.

As shown in FIG. 4, in the illustrated embodiment, the first surface 23a of each of the locking serrations 23 extends generally along an outer contour of the root part 22 (i.e., the first surface 23a also includes a pair of inclined surfaces diverging generally outwardly relative to the center axis C of the shaft portion 20). As seen in FIGS. 1 and 2, the first and second surfaces 23a and 23b of the locking serration 23 preferably extend axially across an entire portion of the root part 22 that extends between opposed portions of the thread part 21. It will be apparent to those skilled in the art from this disclosure that the number of the locking serrations 23 and the positions of the locking serrations 23 in the root part 22 are not limited to the arrangements described in the illustrated embodiment. More specifically, the number of the locking serrations 23 and the positions thereof can be varied as appropriate based on the specific usage and design considerations for the screw fastener 1.

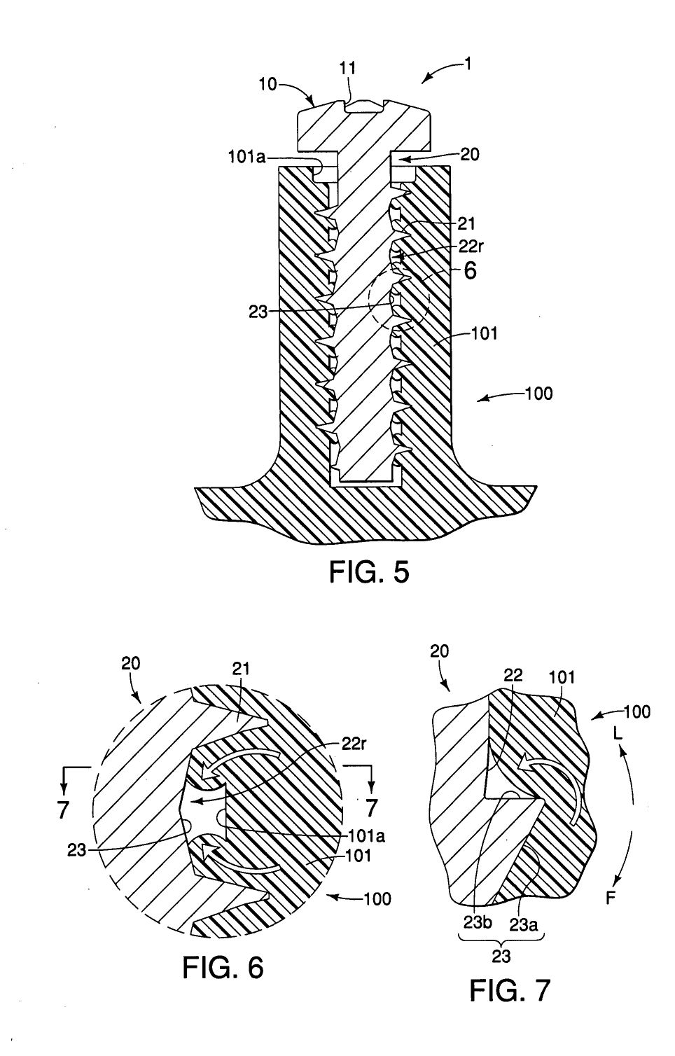

Referring now to FIGS. 5 to 7, operation of the screw fastener 1 will be explained in more detail. FIG. 5 is a cross sectional view illustrating a state in which the screw fastener 1 is threaded into a mounting boss 101 of a workpiece 100. In the illustrated embodiment, the workpiece 100 is made of a material (e.g., synthetic resin or plastic) having lower rigidity than the material (e.g., metal) used for the screw fastener 1. As mentioned above, in the illustrated embodiment, the helical thread structure of the shaft portion 20 is preferably formed as a thread forming screw in this illustrated embodiment. Therefore, the thread part 21 of the shaft portion 20 forms a counter thread in an unthreaded bore 101a of the mounting boss 101 when the shaft portion 20 is rotated in the fastening direction F (FIG. 4) within the mounting boss 101 of the workpiece 100.

FIG. 6 is an enlarged schematic view of an encircled section 6 in FIG. 5 illustrating a flow of material of the mounting boss 101 of the workpiece 100. As shown in FIG. 6, the material of the mounting boss 101, which is moved as the thread part 21 engages the mounting boss 101, flows into the helical recess section 22r formed in the root part 22 as indicated by arrows in FIG. 6. Therefore, the thread part 21 penetrates into the material of the workpiece 100 until the base portion (the portion between the thread part 21 and the root part 22) engages the material. With such arrangement of the root part 22 provided with the helical recess section 22r, the installation torque required to fasten the screw fastener 1 in the workpiece 100 can be reduced, and the clamp load can be improved.

FIG. 7 is a schematic cross sectional view of the screw fastener 1 and the workpiece 100 as taken along a section line. 7-7 in FIG. 6 illustrating a flow of material of the workpiece 100 at the locking serration 23. In the present invention, the material of the workpiece 100 also flows in a groove formed by each of the locking serrations 23 as indicated by an arrow in FIG. 7 after the shaft portion 20 is seated in the mounting boss 101. More specifically, as indicated by the arrow in FIG. 7, the relaxation of the material backflows in a space formed between the second surface 23b of the locking serration 23 and the root part 22 due to the natural creep effect of the material. Therefore, the locking serrations 23 interlock with the material of the workpiece 100 with respect to the loosening direction L (non-fastening direction) as shown in FIG. 7. As a result, the shaft portion 20 is prevented from rotating in the loosening direction L once the shaft portion 20 of the screw fastener 1 is seated in the mounting boss 101 of the workpiece 100.

Accordingly, the screw fastener 1 with the locking serrations 23 in accordance with the present invention provides an improved resistance to loosening. Moreover, when the screw fastener 1 is used in a vibrating machine such as a vehicle, the interlocking connections between the locking serrations 23 of the screw fastener 1 and a mounting boss formed in a vehicle part can achieve an improved vibration resistance. Furthermore, with the screw fastener 1 of the present invention, the locking serrations 23 are arranged such that the rotation of the shaft portion 20 in the fastening direction F is allowed while the rotation of the shaft portion 20 in the loosening direction L is restricted upon engaging with the workpiece 100. Therefore, the hole size (internal diameter) of the unthreaded bore 101 a of the mounting boss 101 can be increased so that the installation force required to fasten the screw fastener 1 to the workpiece 100 can be relatively small. In other words, even if the hole size of the mounting boss 101 is increased to lower the installation force of the screw fastener 1, the screw fastener 1 is securely seated in the mounting boss 101 because the locking serrations 23 achieve the interlocking connections with the workpiece 100 with respect to the rotation in the loosening direction L as shown in FIG. 7. In addition, the screw fastener 1 having the locking serrations 23 in accordance with the present invention can be relatively easily manufactured, and die life can be improved.

Although in the illustrated embodiment, the screw fastener 1 is explained as being made of metal and the workpiece 100 is explained as being made of plastic, it will be apparent to those skilled in the art from this disclosure that the materials of the screw fastener 1 and the workpiece 100 are not limited to such arrangements. For example, the screw fastener 1 and the workpiece 100 can be both made of the same material such as metal, plastic, etc. Moreover, the screw fastener 1 and/or the workpiece 100 can be made of wood or some other material.

Also, in the illustrated embodiment, the screw fastener 1 is explained as being a thread forming screw that forms a counter thread in the unthreaded bore 101a of the mounting boss 101. However, the screw fastener 1 of the present invention is not limited to be used only with an unthreaded bore. More specifically, the screw fastener 1 in accordance with the present invention can be used in a mounting boss having a threaded bore that has matching internal threads to the helical thread structure of the shaft portion 20.

Moreover, the screw fastener 1 can be arranged such that the root part 22 of the shaft portion 20 does not include the helical recess section 22r. In other words, the locking serrations 23 of the present invention can be adapted to other screw designs that do not include the helical recess section 22r in the root part 22.

### General Interpretation of Terms

In understanding the scope of the present invention, the term “comprising” and its derivatives, as used herein, are intended to be open ended terms that specify the presence of the stated features, elements and/or components, but do not exclude the presence of other unstated features, elements, components and/or components. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A screw fastener comprising:
a head portion;
a shaft portion extending from the head portion, the shaft portion having a helical thread structure defining a thread part and a root part; and
at least one locking serration protruding from the root part of-the helical thread structure, the at least one locking serration being configured and arranged to allow rotation of the shaft portion in a fastening direction and to restrict rotation of the shaft portion in a non-fastening direction upon engaging with a workpiece.

2. The screw fastener as recited in claim 1, wherein
the at least one locking serration includes a ratchet tooth formed by a first surface extending generally along an expanding circumferential direction with respect to a center axis of the shaft portion and a second surface extending between the first surface and the root part generally along a radial direction with respect to the center axis of the shaft portion in a plane perpendicular to the center axis of the shaft portion.

3. The screw fastener as recited in claim 2, wherein
the first and second surfaces of the at least one locking serration extend axially across an entire portion of the root part that extends between opposed portions of the thread part.

4. The screw fastener as recited in claim 1, wherein
the at least one locking serration includes a plurality of locking serrations formed on the root part of the helical thread structure, with the locking serrations being spaced apart in a circumferential direction of the shaft portion.

5. The screw fastener as recited in claim 1, wherein
the helical thread structure includes a thread forming profile configured and arranged to form a counter thread in the workpiece when the shaft portion is rotated in the fastening direction when engaging with the workpiece.

6. The screw fastener as recited in claim 1, wherein
the root part of the helical thread structure includes a pair of inclined surfaces diverging outwardly-relative to a center axis of the shaft portion and defining a helical recess section extending substantially parallel to the thread part of the helical thread structure.

7. A screw fastener comprising:
a head portion;
a shaft portion extending from the head portion having a helical thread structure defining a thread part and a root part, the root part of the helical thread structure including a pair of inclined surfaces diverging outwardly relative to a center axis of the shaft portion and defining a helical recess section extending substantially parallel to the thread part of the helical thread structure; and
at least one locking serration protruding from the root part of the helical thread structure across the helical recess section.

8. The screw fastener as recited in claim 7, wherein
the at least one locking serration includes a ratchet tooth formed by a first surface extending generally along an expanding circumferential direction with respect to a center axis of the shaft portion and a second surface extending between the first surface and the root part generally along a radial direction with respect to the center axis of the shaft portion in a plane perpendicular to the center axis of the shaft portion.

9. The screw fastener as recited in claim 8, wherein
the first and second surfaces of the at least one locking serration extend axially across an entire portion of the root part that extends between opposed portions of the thread part.

10. The screw fastener as recited in claim 7, wherein
the at least one locking serration includes a plurality of locking serrations formed on the root part of the helical thread structure,.with the locking serrations being spaced apart in a circumferential direction of the shaft portion.

11. The screw fastener as recited in claim 7, wherein
the helical thread structure includes a thread forming profile configured and arranged to form a counter thread in a workpiece when the shaft portion is rotated in the fastening direction when engaging with the workpiece.
